(19) United States
(12) Patent Application Publication
(10) Pub. No.: US 2015/0241860 A1
(43) Pub. Date: Aug. 27, 2015

(54) INTELLIGENT HOME AND OFFICE AUTOMATION SYSTEM

(71) Applicant: John Raid, Cedar Rapids, IA (US)

(72) Inventor: John Raid, Cedar Rapids, IA (US)

(73) Assignee: RAID AND RAID, INC., D/B/A RUMINATE, Cedar Rapids, IA (US)

(21) Appl. No.: 14/630,523

(22) Filed: Feb. 24, 2015

Related U.S. Application Data
(60) Provisional application No. 61/943,998, filed on Feb. 24, 2014.

(51) Int. Cl. G05B 15/02; H04L 12/28

(52) U.S. Cl. CPC G05B 15/02; H04L 12/2803

(57) ABSTRACT

In general terms, this disclosure is directed to an intelligent home and office automation system. An intelligent automation system, comprises one or more sensors configured to detect activity; a transceiver; a processor communicatively connected to the transceiver, the processor configured to control a remotely located device; wherein, in response to detecting activity, the one or more sensors are configured to send detection signals to the transceiver, wherein the transceiver is configured to communicate the received detection signals to the processor; and wherein the processor is configured to control one or more local devices based on the received detection signals.

### CROSS-REFERENCE TO RELATED APPLICATIONS

The present application claims priority from U.S. Provisional Patent Application No. 61/943,998, filed on Feb. 24, 2014, and entitled LEARNING ROOM OCCUPANCY DETECTION FOR ELECTRONIC FUNCTION INITIATION AND NOTIFICATION, the disclosure of which is hereby incorporated by reference in its entirety.

### BACKGROUND

Current home and business automation systems allow owners to perform various tasks such as remotely adjusting lights and remotely accessing thermostats. Enabling the remote control of such systems provides home and business owners with the comfort in knowing that they have the capability to control such systems if they are away for long periods of time. However, such remote home and business automation systems are limited. In particular, current remote home automation systems are limited in (1) the types of devices in which they can control; (2) the functions over which they can control; and (3) the methods in which they control the devices. Still further, these remote home automation systems oftentimes perform functions only when instructed, by a home or business owner, to do so.

Automated house lighting systems often use simple pyroelectric infrared (PIR) detectors and timers to turn lights on and off based on the time of day or the day of the week, as externally programmed. Still further, office lights may be programmed such that the lights are on during core business hours without taking into consideration employee work schedules wherein employees are not necessarily in their office. Accordingly, such passive systems that merely result in a significant waste of energy.

### SUMMARY

In general terms, this disclosure is directed to intelligent home and office automation systems. In one possible configuration and by non-limiting example, the intelligent home and office automation system is directed to an intelligent automation system, comprising: one or more sensors configured to detect activity; a transceiver; a processor communicatively connected to the transceiver, the processor configured to control a remotely located device; wherein, in response to detecting activity, the one or more sensors are configured to send detection signals to the transceiver, wherein the transceiver is configured to communicate the received detection signals to the processor; and wherein the processor is configured to control one or more local devices based on the received detection signals.

In a second possible configuration, the intelligent home and office automation system is directed to a method for controlling devices based on presence information, the method comprising: receiving an activation signal; listening, using one or more sensors, for activity; detecting, using the one or more sensors, activity; determining whether the activity corresponds to presence information; and sending, to a remotely located computing device, in response to a determination that the activity corresponds to presence information, a notification comprising the presence information.

In a third possible configuration, the intelligent home and office automation system is directed to an intelligent lamp, comprising: one or more sensors configured to detect activity; a transceiver; a processor communicatively connected to the transceiver, the processor configured to control a remotely located device; wherein, in response to detecting activity, the one or more sensors are configured to send detection signals to the transceiver, wherein the transceiver is configured to communicate the received detection signals to the processor; and wherein the processor is configured to control one or more local devices based on the received detection signals.

### BRIEF DESCRIPTION OF THE DRAWINGS

FIG. 1 illustrates an example schematic block diagram of an environment in which an intelligent home and office automation system is used.

FIG. 2 illustrates example systems to which sensors of the intelligent home and office system are connected.

FIG. 3 illustrates an example embodiment of the intelligent home automation system.

FIG. 4 illustrates a block diagram of an example sensor and processor circuitry of the intelligent home automation system.

FIG. 5 is a flow diagram of an example method for detecting activity and performing actions.

FIGS. 6A and 6B illustrate a diagram for detecting patterned behavior.

FIG. 7 illustrates an exemplary architecture of a computing device that can be used to implement aspects of the present disclosure.

FIG. 8 illustrates an alternative embodiment of the intelligent home automation system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general terms, the present disclosure relates to intelligent home and office automation systems. For purposes of this disclosure, references to intelligent systems as used in residential homes may similarly be extended to use in office environments. Aspects of the present disclosure relate to an intelligent, network-connected sensor and communication system (hereinafter referred to as “intelligent home automation system”) that is configured to detect presence of individuals, monitor external events, provide feedback, and adjust in-home systems accordingly.

In particular, aspects of the present disclosure relate to intelligent monitoring systems capable of detecting and providing a home or business owner with information related to the presence of individuals in the home, the power status of lights, fans, and electronic devices (i.e., whether those devices are on or off), the current temperature and humidity levels, the flow of a faucet (i.e., whether a water faucet is leaking/running), the lock status of windows and doors, and the status of various systems (e.g., furnaces, toilets, refrigerators, etc.), and the status of a security system (i.e., whether the security system is activated or deactivated). Although this disclosure lists various capabilities of the intelligent home automation system, such a list is not intended to be exhaustive.

In addition to detection and notification capabilities, the intelligent home automation system is further capable of automatically performing actions in response to, or independent of, receiving instructions from the home or business owner. For example, embodiments of the present disclosure provide that the intelligent home automation system may detect the presence of a child who arrived home from school and thereafter adjust the thermostat to a desired level and turn on particular lights while also notifying the parents of their arrival. Still further, the intelligent home automation system may detect whether an intruder is present in the home and automatically notify authorities. In addition to presence and non-presence, the intelligent home and business automation system may provide, to the home or business owner, information related to the health of systems, such as the detection of unusual noises from the furnace or the detection of a pipe leak. Still further, the intelligent home and business automation system is network connected and can schedule maintenance repairs or order parts either in response to, or independent of, a response from, the home or business owner. Still further, the disclosed intelligent home automation system is network connected and may identify the sound of opening movie titles as matched from an audio database and thereafter automatically dim lights in response to determining that an individual is watching a movie. Additionally, the intelligent home automation system can perform various functions in response to receiving spoken input. For example, an individual in the home can instruct the intelligent home automation system to dim lights, adjust the temperature, or lock doors. Further examples and illustrations will be described in further detail with references to the figures, below.

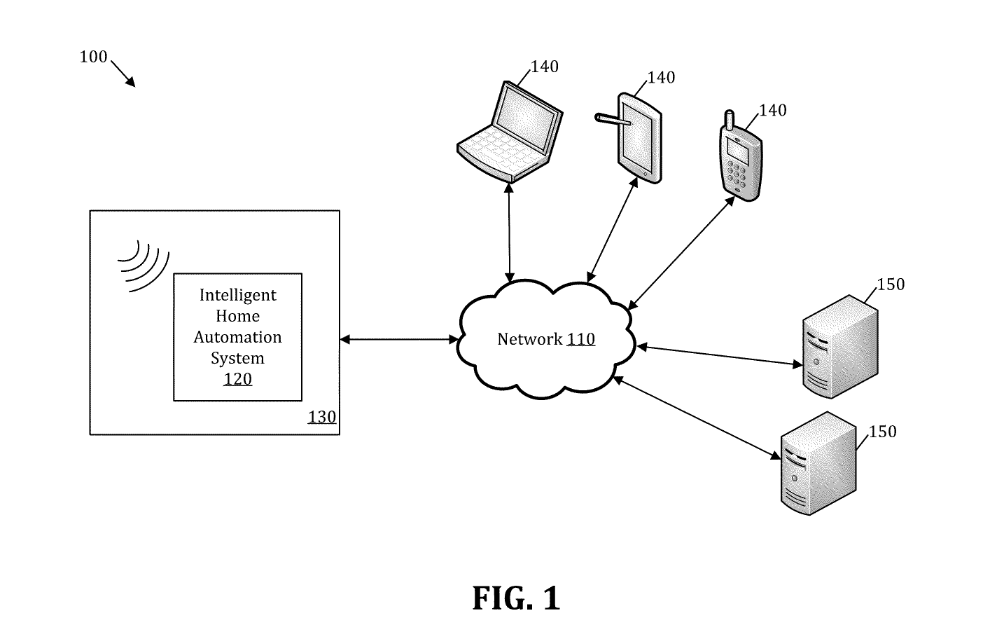

FIG. 1 illustrates an example schematic block diagram of an environment 100 in which an intelligent home automation system 120 is used. As shown in this example embodiment, the intelligent home automation system 120 is located inside a residential or business building 130. As will be described in further detail herein, the intelligent home automation system 120 comprises at least one sensor that is capable of detecting various external events, presence, and activity (hereinafter referred to as “signals’) within proximity to the sensor. In some embodiments, the intelligent home automation system 120 is embedded in a lamp, wherein the lamp contains one or more sensors, a microphone, and camera. In other embodiments, the intelligent home automation system 120 is embedded in other objects such as, but not limited to, lamps/lighting, televisions, stereo systems, garage doors, thermostats, water heaters, outlets, fixtures, and furniture. Yet in other embodiments, the one or more sensors, microphone, and camera are contained in a plurality of objects, wherein each sensor, microphone, and camera are communicatively connected to a processor.

In some embodiments, the intelligent home automation system 120 is configured to process the various signals received from the one or more sensors. For example, the intelligent home automation system 120 is configured to process and determine details related to the detected signal (e.g., determine that a person is present in a particular room and/or identify the person based on the detected person's look or voice). In some embodiments, the intelligent home automation system 120 is capable of digitizing audio signals and processing those signals within the system. Alternatively, the intelligent home automation system 120 sends, over the network 110, the digitized signals to an off-board processor to a local device or a server farm, for example to process. In some embodiments, the intelligent home automation system 120 receives keywords and responds accordingly. In an example, the intelligent home automation system 120 may receive a command such as “dim light by 25%” and either processes that voice command internally or sends a digitized version of the voice command to an off-board processor, which thereafter returns keywords or commands understandable by the intelligent home automation system 120.

The intelligent home automation system 120 is further configured to communicate, over a network 110, information relating to the identified signal(s) to one or more computing devices 140 and/or one or more servers 150. Still further, the intelligent home automation system 120 is configured to receive, over the network 110, instructions from the computing devices 140 in response to the detected signal(s). In some embodiments, these instructions are in the form of digital data commands, and in other embodiments these instructions are in the form of audio speech signals. In some embodiments, the intelligent home automation system 120 is also configured to send and receive, over the network 110,

In some embodiments, the one or more computing devices 140 are used by a home or business owner to receive alerts from, and provide instructions to, the intelligent home automation system 120. Examples of computing devices include desktop computing devices and mobile computing devices. An example desktop computing device is a personal computer or a network configured television. An example mobile computing device is a smartphone, a laptop computer, a smart watch, a personal digital assistant, a tablet computer, and the like.

In some embodiments, the one or more servers 150 may be a single server or multiple servers positioned in a single location or distributed across multiple locations, utilizing data communication over the network 110, for example. In some embodiments, the one or more servers 150 may be used for data processing of signals received from the intelligent home automation system 120. For example, the one or more servers 150 may be configured to receive, from the intelligent home automation system 120, digitized or non-digitized speech signals. Once received, in some embodiments, the one or more servers 150 may perform further data processing on the speech signals and thereafter communicate the processed signals to the intelligent home automation system 120 or the one or more computing devices 140.

As described herein, the data communication network 110 permits digital data to be communicated between the intelligent home automation system 120, the one or more computing devices 140, and one or more servers 150. An example of a data communication network 110 is a wide area network such as the Internet. The data communication network 110 can include multiple communication networks that collectively perform the data communication. Examples of such networks include the Internet, a local area network, a wireless or cellular communication network, and the like.

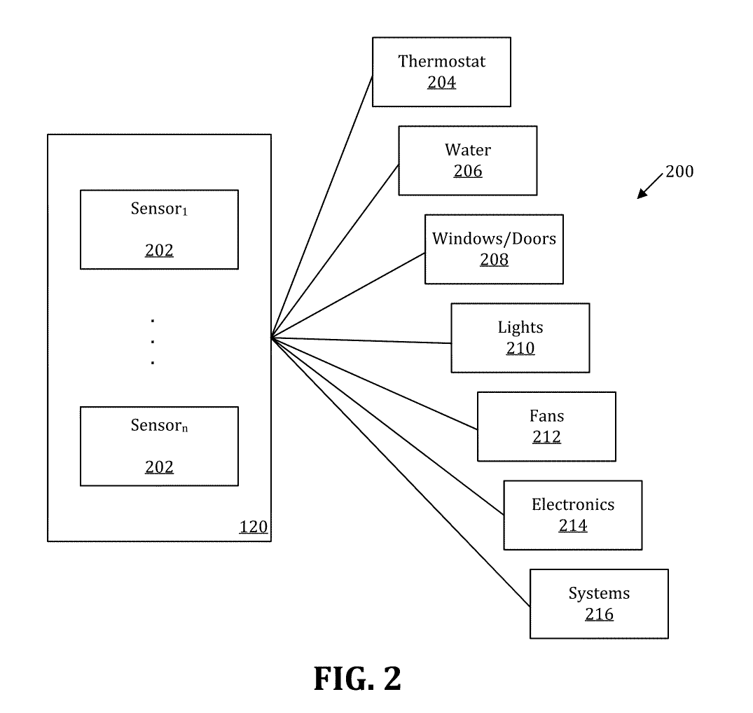

FIG. 2 is a block diagram illustrative of example systems 200 to which sensors 202 of the intelligent home automation system 120 may be connected. As illustrated in FIG. 2, the intelligent home automation system 120 includes one or more sensors 202₁-202ₙ. In example embodiments, the one or more sensors are a combination of the following: a Pyroelectric Infrared Detector (PIR), a capacitive touch sensor, a microphone, an ambient light sensor, an active infrared detector, a video camera, a still camera, and a temperature and humidity sensor. Additionally, in some embodiments, such sensors are housed in one or more objects such as, but not limited to, lamps/lighting, televisions, stereo systems, garage doors, thermostats, water heaters, outlets, fixtures, and furniture.

As described herein, the one or more sensors 202₁-202ₙ are capable of detecting, but not limited to, the following: presence of individuals in a room, the ambient room temperature and humidity, and the level of light, etc.

The one or more sensors 202₁-202ₙ of the intelligent home automation system 120 may be installed in such objects in various rooms, hallways, corridors, to monitor such spaces, but they may also be placed in a position to monitor various in-home systems 200. As illustrated, the one or more systems 200 may include, for example, a thermostat 204, water systems 206, windows and doors 208, lights 208, fans 210, electronics 212, and other systems 214. In some embodiments, the sensors 202₁-202ₙ are positioned in proximity to each of the systems 200, thereby providing enhanced capability to detect activity or abnormalities related to each system 200. In some embodiments, the sensors may be capable of detecting, for example, noise associated with the furnace or water pipes and determining whether the furnace is broken or whether pipes are leaking.

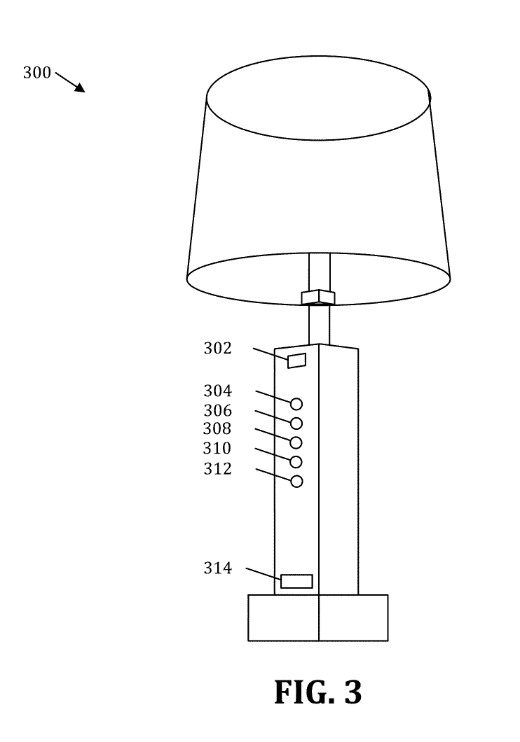

FIG. 3 illustrates an example embodiment of the intelligent home automation system. In this example, the intelligent home automation system is embodied in a lamp 300. In this embodiment, the lamp 300 includes one or more sensors 302-310, a microphone 312, a video camera 314, a processor (not shown), a communication device (not shown) to communicate to other network connected lamps or sensors, and a light source, such as a light emitting diode (LED). The microphone 312 and video camera 314 are similarly considered sensors for purposes of this disclosure. As shown in this example, the sensors 302-310 are positioned inside of the lamp 300, however in other embodiments, the sensors 302-310 may be located in other positions on the lamp 300.

In this embodiment, sensor 302 may be a pyroelectric infrared detector (PIR), sensor 304 may be an ambient light sensor, sensor 306 may be an infrared detector, sensor 308 may be a capacitive touch sensor, and sensor 310 may be a temperature sensor. Although five sensors sensors 302-310 are illustrated, it is understood to one of ordinary skill in the art that more or fewer sensors may alternatively be implemented in the lamp 300 or intelligent home automation system 120 as described herein. As illustrated, in addition to sensors 302-310, the lamp 300 additionally includes a microphone 312 and a video camera 314. Although the lamp 300 is embodied as a table lamp, the lamp 300 may also take the form of under cabinet task lighting, desk lighting, piano lighting, and office lighting.

Each of the sensors 302-310, microphone 312, and video camera 314 consider various conditions such as, for example, the time of day, ambient light level, and ambient audio signals. The sensors 302-310, microphone, and video camera 314 operate together to detect various sounds, temperatures, and light levels in order to identify subsequent actions. For example, the lamp 300 may detect the sound associated with the sharp slam of a car door, and thereafter determine that someone has arrived. Additionally, using a combination of the sensors 302-310, microphone 312, and video camera 314, the lamp 300 may determine the number of people who have arrived, and still further, identify the persons in particular who have arrived. Additionally, the sensors 302-208, microphone 312, and video camera 314 are sufficiently intelligent to identify movement from pets in order to discern that the movement is not related to human activity, for example, by activation of the camera 314.

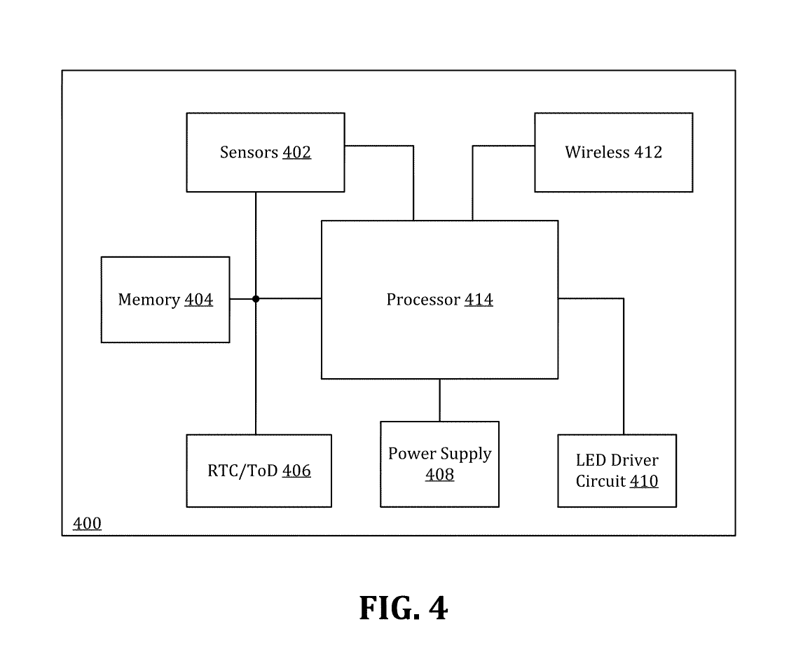

As described herein and in further detail with reference to FIG. 4, the lamp 300 is equipped with a communication device, enabling it to communicate with the home owner. Continuing the example, above, if the lamp 300 identifies the presence of an individual in the home, the lamp 300 may contact, over the network 110, and inform the home owner of the identification of such activity. As described, the lamp 300 may contact the home owner on any one of the home owner's computing devices 140, as illustrated and described with reference to FIG. 1. Furthermore, the lamp 300 may receive feedback from the home owner or may automatically perform various tasks. For example, if the home owner is informed that an individual is present in the home, the home owner may adjust, using a computing device 140, the thermostat or adjust the lighting. Alternatively, if the individual present in the home is an unidentified individual, the home owner may contact authorities. Alternatively, the lamp 300 may automatically perform such tasks without receiving feedback from the home owner. For example, in some embodiments, the lamp 300 may store, in memory, tasks to automatically perform in response to the detection of such activity. Alternatively, the storage of such tasks in response to the detection and identification of particular activities may be stored in a remotely located database accessible by the lamp 300 over the network 110.

In other embodiments, the lamp 300 may be programmable to alert the home owner whether certain events do not occur. For example, the home owner may set the lamp to send an alert if an individual did not arrive home at a pre-set day and time. In an example, a parent may program the lamp 300 to send a notification if a child does not return home by a certain, predetermined time.

In other embodiments, the lamp 300 may turn off in response to detecting when an individual leaves the room in which the lamp 300 is positioned. Still further, the sensors 302-310, microphone 312, and video camera 314 may identify the room to which the individual is relocating, and in response, instruct a lamp 300 positioned in that particular room to turn on. Alternatively or additionally, the lamp 300 may instruct other lights positioned along the path to turn on. As described herein, sensors and electronics associated with the intelligent home automation system may be positioned in various electronic devices. Accordingly, in response to identifying the room to which the individual is relocating, the lamp 300 may instruct other devices located in that particular room, such as a fan or television, to turn on. Relatedly, the lamp 300 may instruct electronic devices of the recently vacated room to turn off.

Although the embodiment described in FIG. 3 illustrates a lamp 300, aspects of this disclosure are not limited thereto. As described herein, the intelligent home automation system may be implemented in various devices, such as, but not limited to, televisions, stereo systems, garage doors, thermostats, water heaters, outlets, fixtures, and furniture.

FIG. 4 illustrates a schematic block diagram of an example sensor and processor circuitry 400 of the intelligent home automation system 120 as implemented in a lamp 300. In this example embodiment, the circuitry includes sensor circuitry 402, memory 404, a real time clock/time of day (RTC/ToD) circuit 406, a power supply 408, an LED driver circuit 410, wireless communication circuitry 412, which are electrically connected to a processor 414.

In this example, the sensor circuitry 402 includes, for example, driver circuitry for operating the one or more sensors as implemented in the intelligent home automation system 120. The memory 404 may include read only memory and random access memory for storing instructions and data received from the one or more sensors.

In this example, the RTC/ToD circuit 406 is used for correlation with respect to the lighting functionality of the lamp 300. For example, the RTC/ToD circuit 406 identifies, stores, and analyzes historical ambient light data over time. Accordingly, the lamp 300 is configured to track the long term change in ambient light over time in order to accurately estimate the correct latitude and correct time of day if time cannot be established using an internet connection. Determining the correct time of day is accomplished by curve fitting a polynomial to the daily light level to identify the sunrise and sunset. Thereafter, each day sunrise and sunset is compared over a period of months, wherein each month is associated with a sinusoid. Accordingly, the RTC/ToD circuit 406 determines that the maximum of the sinusoid corresponds to summer months and the minimum of the sinusoid corresponds to winter months, wherein the difference between the two corresponds to the latitude where the lamp is located. Such information can be used to determine if the lamp 300 is located in a warm or a cold climate and to determine the present season.

In this example embodiment, the switch mode power supply 408 converts AC wall outlet power to 24, 5, and 3.3 volts direct current (VDC), which is used to power the active components of the sensor and processor circuitry 400. For example, 5 VDC and 3.3 VDC may be supplied to the processor 414 and wireless communication circuitry 408 while 24 VDC is supplied to the LED driver circuitry 412.

Further, the LED driver circuit 410 may be, for example, a buck converter that is capable of efficiently dimming LED strings according to a pulse width modulated signal provided by the processor 414. Still further, the wireless communication circuitry 412 includes, for example, a Wi-Fi module or wireless connectivity chip enabling the lamp 300 to communicate over a wireless network following IEEE802.11 standards.

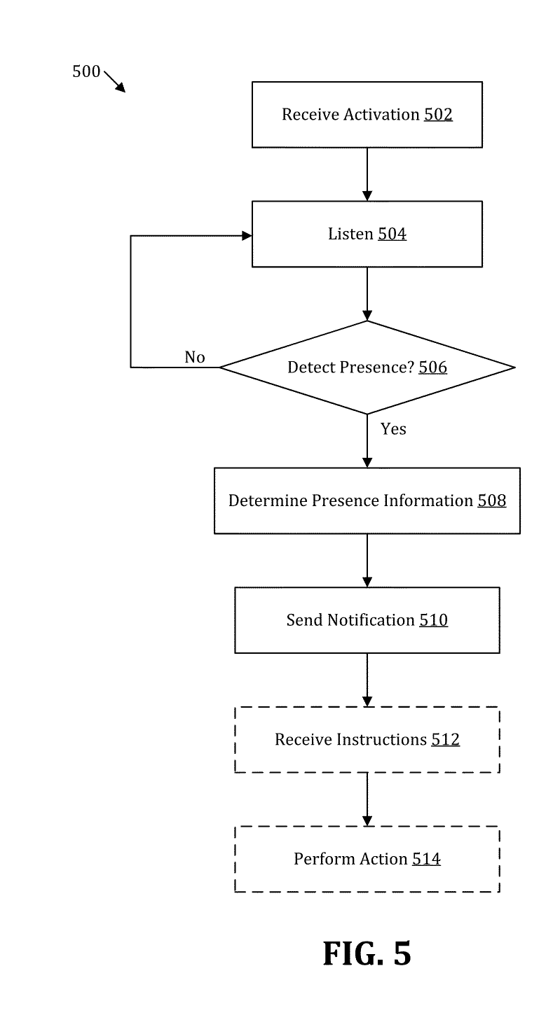

FIG. 5 is a flow diagram of an example method 500 for detecting activity and performing actions. In particular, the example method 500 describes the determination of presence according to aspects of the present disclosure. This example embodiment illustrates the determination of presence using a lamp, such as lamp 300, as the intelligent home automation system 120, however as described herein, this disclosure is not limited thereto and is configured to be implemented in multiple ways.

The example method 500, begins at the receive activation step 502. In the receive activation step 502, the device that embodies the intelligent home automation system 120 is activated. For example, the lamp 300 may be turned on. Alternatively or additionally, the sensors, microphone, and video camera of the lamp 300 may be directed to a mode ready for identifying presence of individuals in the room.

Next, the method 500 flows to the listen step 504 wherein the lamp 300 awaits activity. In an example, the microphone 312 and/or camera 314 are activated, wherein the microphone 312 and video camera 314 listen and watch for activity, respectively. For example, the microphone 312 may listen for activity outside of the home, such as the slamming of a car door, the opening of a door or garage door, voices or other movement within the home. Additionally, the video camera 314 may await movement activity. Alternatively, the video camera 314 may be activated in response to activity detected by the microphone 312. As described herein, the video camera 314 may identify differences between the presence of a human individual and a pet, such as a dog that roams into a room within the vicinity of the lamp 300. In some example embodiments, the temperature sensor 310 may detect an increase in ambient temperature, thereby indicating that a person has entered the home or room. In some embodiments, one or more sensors communicatively operate to determine whether an individual is present in the room.

Next, flow moves to the detect presence decision block 506. In the detect presence decision block 506, the lamp 300 determines whether presence is detected, as described above with reference to step 504. If presence is not detected (NO), the lamp 300 returns to step 504 and continues to listen for presence activity. If, however, presence is detected (YES), the method 500 flows to step 508.

In the determine presence information step 508, the lamp 300 determines, for example, the number of individuals present in the home, the identity of each individual, the room(s) in which each individual is located, and the activity in which each individual is engaged. In an example embodiment, the camera 314 uses face detection analysis and correlates the analysis with the identity of known individuals to identify each individual present in the home. In example embodiments, the memory 404 stores the faces of known individuals, yet in other embodiments, the pictures of present individuals are sent, over the network 110, to the one or more servers 150, wherein the face detection analysis and identification correlation is performed. The one or more servers 150 may thereafter send presence information to the lamp 300, the one or more computing devices 140, or both. Additionally, for example, the microphone 310 can determine whether the television is on to conclude that the identified individual is watching television.

Although the determine presence information step 508 describes the determination of the number of individuals present in the home and related data, it is also within the scope of this disclosure to determine non-presence information. For example, the lamp 300 may also determine when individuals have left the room or the home altogether by no longer detecting activity or by detecting the opening and closing of a door, indicating that an individual has left the home.

In some embodiments, the lamp 300 sends signals related to the detected activity or the presence information to one or more remotely located servers 150 for off-board processing. For example, the remotely located servers 150 may process and determine that audio signals related to activity detected by the microphone 312 are attributable to the presence of one or more individuals in the home. Alternatively or additionally, the remotely located servers 150 may process and determine that video or pictures captured by camera 314 are attributable to the presence of one or more individuals in the home, and may additionally identify said individuals.

Next, flow moves to the send notification step 510. In the send notification step 510, the lamp 300 sends presence information to the home owner. In some embodiments, the lamp 300 sends at least one of the following information: the number of individuals present in the home, the time of each individual's arrival in the home, the identity of each present individual, the location of each individual in the home, and the activity in which each individual is engaged. In other embodiments, the lamp 300 sends the home owner other information. As described herein, the lamp 300 sends the one or more computing devices 140 such notification information. In some embodiments, the notification information is sent in the form of a short message service (SMS), an email, an automated phone call, or a notification through an application installed on the computing device 140.

Next, flow may proceed to the receive instructions step 512. As indicated by dashed lines, this is an optional step of the method 500. In this optional receive instructions step 512, the lamp 300 receives, over the network 110, instructions from the one or more computing devices 140. In some embodiments, the home owner may, using the one or more computing devices 140, send, over the network 110, to the lamp 300, instructions in response to receiving presence information. Such instructions may be, for example, to adjust the thermostat, to turn on lights, fans, or other electronics, or to lock doors or windows. The home owner may use an application, software program installed on the one or more computing devices 140, or the Internet to send such instructions to the lamp 300.

Next, the method 500 may proceed to the optional perform action step 514. As indicated by the dashed lines, the perform action step 514 is an optional step and may not necessarily be executed by the method 500. In the perform action step 514, the lamp 300 receives the instructions from the one or more computing devices 140 and thereafter performs the action associated with the received instructions. For example, the lamp 300 may, in response to receiving the instructions, communicate with the thermostat to adjust the temperature to a desired level. In another example, the lamp 300 may communicate with other lamps or lighting throughout the home to turn on. As described herein, the lamp 300 may communicate with each of the devices within the home via a Wi-Fi network, for example, wherein each device includes a communication device for receiving instructions from the lamp 300.

Alternatively, the lamp 300 is configured to automatically perform actions, such as controlling one or more local devices in response to determining presence information. In such an example embodiment, upon a determination of presence information in step 508, the lamp 300 may automatically control one or more local devices. Yet in other embodiments, the memory 404 may store profile information for known individuals and upon a determination of presence information in step 508, the lamp 300 may automatically control one or more local devices based on the present individual's profile (e.g., adjust the temperature of the thermostat to the identified present individual's temperature preference).

In some embodiments the method 500 for detecting presence information is performed by microprocessor 414. In alternative embodiments, the method 500 for detecting presence information is performed by a combination of microprocessors and one or more sensors. Those having ordinary skill in the art will understand that any combination of devices may be used to perform the operations described in method 500.

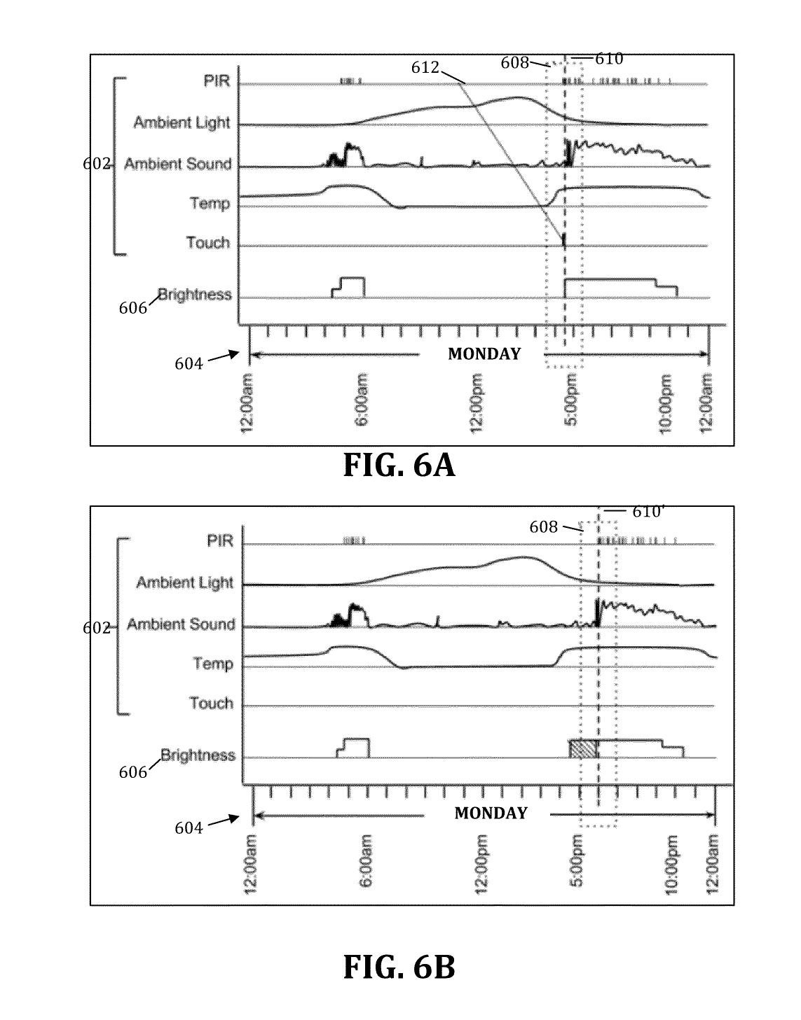

FIG. 6 illustrates a schematic diagram for detecting patterned behavior. As described herein, the intelligent home automation system 120 is configured to detect patterns of an individual's behavior, and to learn the individual's habits and routines in order to predict the individual's behavior and ultimately provide assistance. For example, the intelligent home automation system 120 is configured to learn an individual's nighttime routine by detecting patterns related to when the individual goes to bed, what path the individual takes to walk to the bedroom, and the individual's preferences (e.g., whether the individual turns on a fan, watches television while falling asleep, reads, etc.). Accordingly, upon learning the behavior, the intelligent home automation system 120 is configured to assist the user during or even prior to the identified patterned behavior. In continuing the example described above, the intelligent home automation system 120 may automatically perform the following example actions: turn on the hallway and bedroom lights, turn on the television (and further, to a predetermined channel), turn on the fan, adjust the thermostat, lock the doors and windows, turn off the lights and electronics in the room in which the individual was previously located, and turn off hallway lights once the individual reaches the bedroom.

In an example embodiment, the intelligent home automation system 120 is embodied in a lamp 300 as described herein. In such an example, the lamp 300 is configured to learn from an individual's actions by correlating historical data that is stored within memory 404, for example. For example, data obtained from each sensor 302-310, microphone 312, and camera 314 is recorded and stored in memory 404 within the lamp 300 or is stored in the one or more servers 150 located outside the home. In some embodiments, the data obtained from the sensors 302-310, microphone 312, and camera 314 is stored over days, weeks, months, or years.

As illustrated in the graph shown in FIGS. 6A and 6B, sensor readings 602 are displayed on the X-axis and the date and time 604 are displayed on the Y-axis. As illustrated in this example, the sensor readings are obtained from a PIR sensor 302, an ambient light sensor 304, a capacitive touch sensor 308, a temperature sensor 310, a microphone 312, and a camera 314. As illustrated, FIG. 6A depicts sensor readings obtained from Monday in a first week and FIG. 6B illustrates sensor readings obtained from Monday in a subsequent week. In example embodiments, when the PIR sensor detects movement and is therefore tripped, the video camera 314 uses image processing to determine whether the trip was due to an animal or a human. Additionally, in order to detect patterns, the lamp 300 uses stored historical data relating to ambient light changes throughout the day based on, for example, cloud cover, the position of the sun, the position of the window in the room, and other room lighting from lamps and a television. Still further, the lamp 300 uses historical data relating to ambient sound changes based on activity ranging from low to high frequency sounds (e.g., the differences between the sounds in connection with a faint shower to the sounds in connection with the closing of a door). Furthermore, the lamp 300 uses changes in temperature based on the thermostat settings, the number of individuals in the room, and whether a window is open. Still further, the lamp brightness 606 is included on the X-axis to illustrate the correlation between button presses on the lamp 300 and the responding increase or decrease in brightness levels. As illustrated, correlation is over a window 608 of time that is centered on the current time 610 and relates to current past button presses 612, thereby allowing the lamp 300 to understand situations that might change in time. In an example, if an individual normally comes home at 5:00 PM, as illustrated in FIG. 6A, and a following week arrives home at 6:00 PM, as illustrated in FIG. 6B. Although the historical data illustrates that the individual should be home at 5:00 PM, and thus the lamp 300 should be turned on, the lamp 300 is not turned on because no one is home. Rather, the lamp 300 awaits, for example, a sound associated with a trigger that is similar to a sound that previously occurred prior to the individual turning on the lamp 300 on a previous occasion. For example, the lamp 300 may have previously detected and stored a sound associated with the opening of the garage door, the slamming of a car door, or the opening and closing of a door, which occurred prior to the individual turning on the lamp 300. Accordingly, although the lamp 300 might normally turn on at 5:00 PM when the individual returns home, the lamp 300 may also have learned that certain sounds are associated with certain behaviors (e.g., the individual arriving home) and turn on in response to the detection of such sounds. Thus, the intelligent home and automation system 120 is configured to learn detected patterns of behavior to anticipate such future behavior and respond accordingly. Although the example illustrated herein describes the situation when a user arrives home, aspects of this disclosure are not limited thereto and may be applied in other applicable situations.

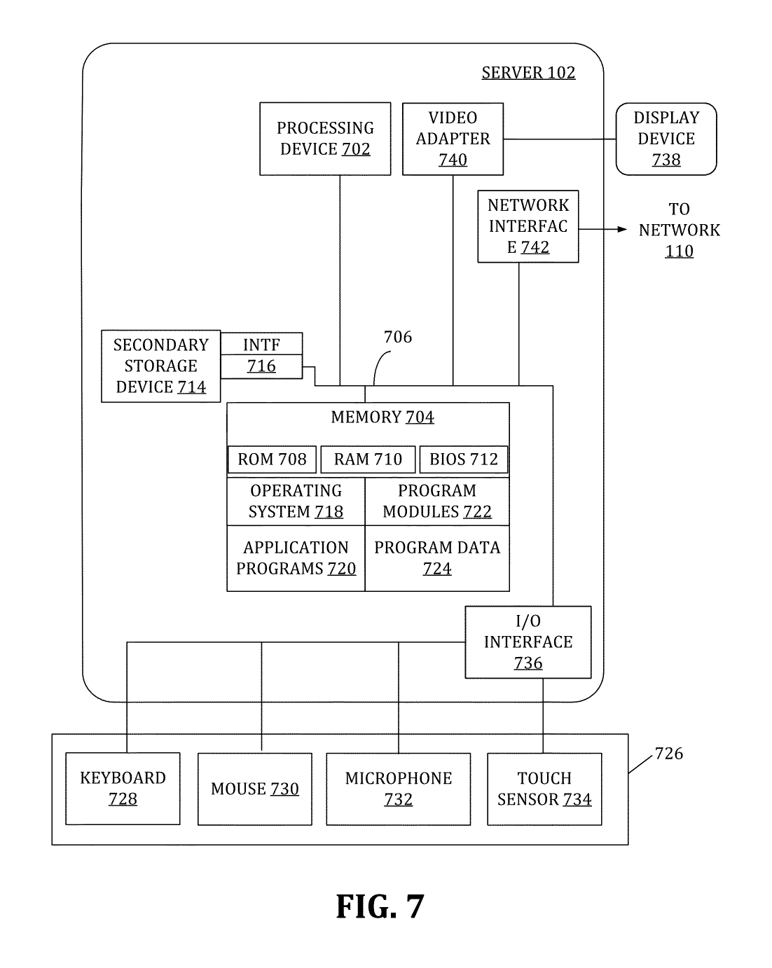

FIG. 7 illustrates an exemplary architecture of a computing device that can be used to implement aspects of the present disclosure. In this disclosure, a laptop or personal computer 140, tablet computing device 140, phone 140, and servers 150 are example computing devices. FIG. 7 can be used to implement aspects of the present disclosure including any of the plurality computing devices 140 and 150 as illustrated in and described with reference to FIG. 1. The computing device described in FIG. 7 can be used to execute the operating system, application programs, and software modules (including the software engines) described herein. By way of example, the computing device will be described below as the computing device 750. To avoid undue repetition, this description of the computing device will not be separately repeated herein for each of the other computing devices, including computing devices 140 and 150, but such devices can also be configured as illustrated and described with reference to FIG. 7.

The computing device 750 includes, in some embodiments, at least one processing device 702, such as a central processing unit (CPU). A variety of processing devices are available from a variety of manufacturers, for example, Intel or AMD. In this example, the computing device 750 also includes a system memory 704, and a system bus 706 that couples various system components including the system memory 704 to the processing device 702. The system bus 706 is one of any number of types of bus structures including a memory bus, or memory controller; a peripheral bus; and a local bus using any of a variety of bus architectures.

Examples of computing devices suitable for the computing device 750 include a desktop computer, a laptop computer, a tablet computer, a mobile computing device (such as a smart phone, an iPod® or iPad® mobile digital device, or other mobile devices), or other devices configured to process digital instructions.

The system memory 704 includes read only memory 708 and random access memory 710. A basic input/output system 712 containing the basic routines that act to transfer information within computing device 750, such as during start up, is typically stored in the read only memory 708.

The computing device 750 also includes a secondary storage device 714 in some embodiments, such as a hard disk drive, for storing digital data. The secondary storage device 714 is connected to the system bus 706 by a secondary storage interface 716. The secondary storage devices 714 and their associated computer readable media provide nonvolatile storage of computer readable instructions (including application programs and program modules), data structures, and other data for the computing device 750.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 716 or memory 704, including an operating system 718, one or more application programs 198, other program modules 722 (such as the software engines described herein, including one or more of the user accounts management engine 202, spending rules engine 204, merchant communication engine 206, transaction communication engine 208, and reporting engine 210), and program data 724. The computing device 750 can utilize any suitable operating system, such as Microsoft Windows™, Google Chrome™, Apple OS, and any other operating system suitable for a computing device.

In some embodiments, a user provides inputs to the computing device 750 through one or more input devices 726. Examples of input devices 726 include a keyboard 728, mouse 730, microphone 732, and touch sensor 734 (such as a touchpad or touch sensitive display). Other embodiments include other input devices 726. The input devices are often connected to the processing device 702 through an input/output interface 736 that is coupled to the system bus 706. These input devices 726 can be connected by any number of input/output interfaces, such as a parallel port, serial port, game port, or a universal serial bus. Wireless communication between input devices and the interface 736 is possible as well, and includes infrared, BLUETOOTH® wireless technology, 802.11a/b/g/n, cellular, or other radio frequency communication systems in some possible embodiments.

In this example embodiment, a display device 738, such as a monitor, liquid crystal display device, projector, or touch sensitive display device, is also connected to the system bus 706 via an interface, such as a video adapter 740. In addition to the display device 738, the computing device 750 can include various other peripheral devices (not shown), such as speakers or a printer.

When used in a local area networking environment or a wide area networking environment (such as the Internet), the computing device 750 is typically connected to the network 744 through a network interface 742 as an Ethernet interface. Other possible embodiments use other communication devices. For example, some embodiments of the computing device 750 include a modem for communicating across the network.

The computing device 750 typically includes at least some form of computer readable media. Computer readable media includes any available media that can be accessed by the computing device 750. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 750. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 7 is also an example of programmable electronics, which may include one or more such computing devices, and when multiple computing devices are included, such computing devices can be coupled together with a suitable data communication network so as to collectively perform the various functions, methods, or operations disclosed herein.

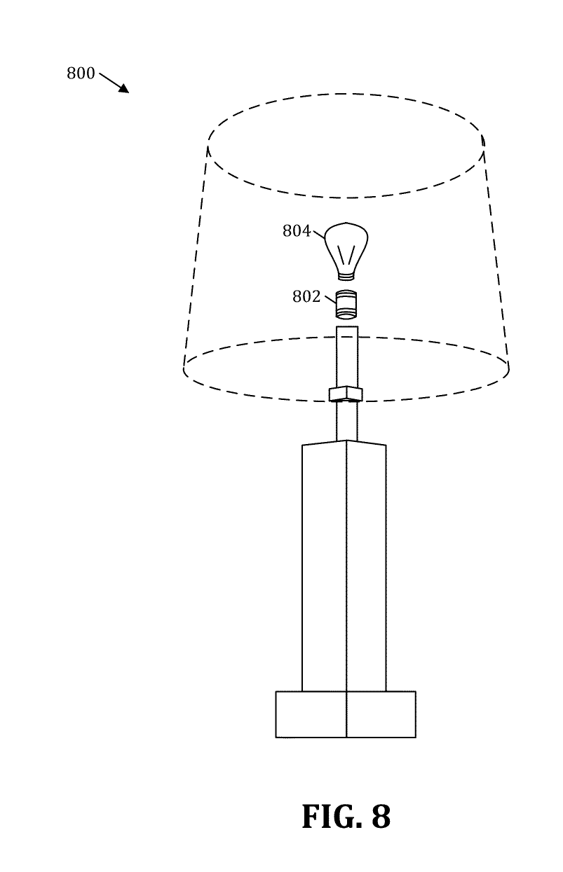

FIG. 8 illustrates an alternative embodiment of the intelligent home automation system. In such an example, the intelligent home automation system can be embodied in an adapter 802 that is detachably connected to the lamp 800. In some embodiments, the adapter 802 is connected directly to the lightbulb 804.

In this example embodiment, the adapter 802 includes one or more sensors, cameras, and microphones. Although this embodiment illustrates the adapter 802 is connected to the lightbulb 804, such an adapter configuration may also be implemented independent of the lamp 800, and detachably connectable to other devices.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. An intelligent automation system, comprising:
one or more sensors configured to detect activity;
a transceiver;
a processor communicatively connected to the transceiver, the processor configured to control a remotely located device;
wherein, in response to detecting activity, the one or more sensors are configured to send detection signals to the transceiver,
wherein the transceiver is configured to communicate the received detection signals to the processor; and
wherein the processor is configured to control one or more local devices based on the received detection signals.

2. The intelligent automation system of claim 1, wherein the one or more sensors comprise a network of sensors.

3. The intelligent automation system of claim 1, further comprising:
the transceiver is configured to send the detection signals to a remotely located computing device;
the transceiver is configured to receive instruction signals from the remotely located computing device;
the transceiver is configured to send the instruction signals to the processor; and
the processor is configured to control the one or more local devices based on the instruction signals.

4. The intelligent automation system of claim 1, wherein the transceiver is further configured to:
send, to a remotely located server, the detection signals; and
receive, from the remotely located server, processed data.

5. The intelligent automation system of claim 4, wherein the processor controls the one or more local devices based on the processed data received from the remotely located server.

6. The intelligent automation system of claim 4, wherein:
the transceiver is configured to send the processed data to a remotely located computing device;
the transceiver is configured to receive instruction signals from the remotely located computing device;
the transceiver is configured to send the instruction signals to the processor; and
the processor is configured to control the one or more local devices based on the instruction signals.

7. The intelligent automation system of claim 1, wherein the one or more sensors are selected from a group comprising: a pyroelectric infrared detector, an ambient light sensor, an infrared detector, a capacitive touch sensor, a temperature sensor, a microphone, and a camera.

8. The intelligent automation system of claim 1, wherein the one or more local devices comprise: a light, a thermostat, a television, a fan, a faucet, a window, a door, a garage door, and a security system.

9. The intelligent automation system of claim 1, wherein the one or more sensors, the transceiver, and the processor are contained in an adapter.

10. A method for controlling devices based on presence information, the method comprising:
receiving an activation signal;
listening, using one or more sensors, for activity;
detecting, using the one or more sensors, activity;
determining whether the activity corresponds to presence information; and
sending, to a remotely located computing device, in response to a determination that the activity corresponds to presence information, a notification comprising the presence information.

11. The method for controlling devices based on presence information of claim 10, further comprising:
receiving instructions based on the sent notification; and
controlling one or more local devices based on the received instructions.

12. The method for controlling devices based on presence information of claim 10, further comprising:
sending, to a remotely located server, the detected activity; and
receiving, from the remotely located server, presence information.

13. The method for controlling devices based on presence information of claim 10,
wherein the presence information further comprises data relating to individuals present in a home;
wherein the data further comprises:
a number of individuals,
an identification of each individual, and
a specific location of each individual.

14. The method for controlling devices based on presence information of claim 11, further comprising:
storing the presence information;
receiving updated presence information;
modifying the stored presence information; and
controlling the one or more local devices based on the modified stored presence information.

15. The method for controlling devices based on presence information of claim 10, further comprising:
storing, in memory, at least one profile comprising user preferences, wherein each profile is associated with a person;
receiving presence information for the person; and
controlling one or more local devices based on the profile of the person.

16. The method for controlling devices based on presence information of claim 15 wherein the profile further comprises past presence information.

17. An intelligent lamp, comprising:
one or more sensors configured to detect activity;
a transceiver;
a processor communicatively connected to the transceiver, the processor configured to control a remotely located device;
wherein, in response to detecting activity, the one or more sensors are configured to send detection signals to the transceiver,
wherein the transceiver is configured to communicate the received detection signals to the processor; and
wherein the processor is configured to control one or more local devices based on the received detection signals.

18. The intelligent lamp of claim 17, further comprising:
the transceiver is configured to send the detection signals to a remotely located computing device;
the transceiver is configured to receive instruction signals from the remotely located computing device;
the transceiver is configured to send the instruction signals to the processor; and
the processor is configured to control the one or more local devices based on the instruction signals.

19. The intelligent lamp of claim 17, wherein the transceiver is further configured to:
send, to a remotely located server, the detection signals; and
receive, from the remotely located server, processed data.

20. The intelligent lamp of claim 19, wherein the processor controls the one or more local devices based on the processed data received from the remotely located server.
